(19) United States
(12) Patent Application Publication
(10) Pub. No.: US 2018/0053429 A1
(43) Pub. Date: Feb. 22, 2018

(54) ARTICLES OF APPAREL FOR TEACHING VOCABULARY

(71) Applicant: Alyssa & Alexander LLC, Coral Gables, FL (US)

(72) Inventors: Sandra M. FERRERA, Coral Gables, FL (US); Marlene A. FERNANDEZ-KARAVETSOS, Miami, FL (US)

(21) Appl. No.: 15/659,785

(22) Filed: Jul. 26, 2017

Related U.S. Application Data
(60) Provisional application No. 62/367,099, filed on Jul. 26, 2016.

(51) Int. Cl. G09B 1/02; A41B 13/00; A41B 1/08; A41D 1/22; G09B 19/06

(52) U.S. Cl. CPC G09B 1/02; A41B 13/005; G09B 19/06; A41D 1/22; A41B 1/08

(57) ABSTRACT

Provided are articles of apparel for assisting education in learning language vocabulary for the wearer and/or the audience viewing the articles of apparel. In one example, the article of apparel includes a first apparel portion having a first color and a second apparel portion having a second color which is different from the first color, wherein the second color is identified within the second apparel portion in a non-English written language. The article of apparel may assist in teaching English and/or non-English language vocabulary for colors, numbers, shapes, body parts, etc.

### FIELD OF THE INVENTION

The present invention relates generally to articles of apparel, more particularly, to articles of apparel for assisting education in learning languages and other symbols, for example learning English or foreign language (non-English) vocabulary, for the wearer and/or the audience viewing a worn article of apparel.

### BACKGROUND OF THE INVENTION

Various articles of apparel have been used to assist in education, particularly for education of infants, toddlers, and children.

U.S. Pat. No. 3,624,686 describes an apron worn by a teacher having pockets of different colors removably attached to the apron. The pockets are of various colors for the teaching of color identification. Color identification is taught to young children by the teacher placing articles of a matching color into a pocket while the children observe.

U.S. Pat. No. 3,724,101 describes a cape that is worn by a teacher and is used to teach the spelling of words. The cape has a number of pockets on the front of the cape, each pocket displaying a different consonant of the alphabet. Inside each pocket is an object which corresponds to the consonant of the pocket. Detachable patches displaying the vowels of the alphabet are attached to the front of the cape.

U.S. Pat. No. 4,710,979 describes a mother's bib with detachable multicolored two dimensional infant toys to aid supervised baby play. The bib may be worn by an adult for interactive play with a young child. The bib has a number of two-dimensional appliques for attachment and detachment by the child. The appliques include the letters of the alphabet, a variety of fastening devices, and toys that make sounds.

Similarly, U.S. Pat. No. 4,723,323 describes a child's activity bib which is designed to be worn by an adult while the child is held on the lap of the adult facing the activity bib. The activity bib has a number of activity means mounted on the front of the bib. These activity means may include a color activity, a texture activity, a shape activity, a number activity, and a pocket activity.

U.S. Pat. No. 5,468,152 describes educational children's clothing. The article of clothing is a garment having a plurality of pockets. Each of the pockets displays at least one member of an educational concept and contains a removable object displaying the educational concept. Each of the removable objects is secured to one of the pockets to prevent disassociation of the objects from the garment.

The articles of apparel described above are generally designed to be worn by an adult for instructive play with infants, toddlers, or children, and include detachable pockets and/or removable articles for teaching alphabet, color, texture, shape, numbers, sounds, spelling, etc.

### SUMMARY OF THE INVENTION

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

In one specific embodiment of the present invention, there is provided an article of apparel which includes a first apparel portion having a first color and a second apparel portion having a second color which is different from the first color, wherein the second color is identified within the second apparel portion by a written foreign (non-English) language.

In another embodiment of the present invention, the written foreign language may be Spanish.

In another embodiment of the present invention, the article of apparel may be wearable by an infant or a toddler. Further, the second apparel portion may cover a foot of the infant or toddler.

In another embodiment of the present invention, the article of apparel may be a dress having a main dress portion as a first apparel portion, and a sleeve as the second apparel portion.

In another embodiment of the present invention, the article of apparel may be a shirt in which a collar is a second apparel portion.

In another embodiment of the present invention, the first color of the first apparel portion is identified within the first apparel portion in a written foreign language.

In another embodiment of the present invention, the second apparel portion is detachably attached to the article of apparel.

Yet in another embodiment of the present invention, an article of apparel includes a first apparel portion and a second apparel portion which is positioned within a boundary having a definable geometric shape, wherein said definable geometric shape is identified within the second apparel portion in either the English language or a foreign language.

In another embodiment of the present invention, the first apparel portion has a first color and the second apparel portion has a second color which is different from the first color, and wherein the second color is identified within the second apparel portion in the written foreign language.

In yet another embodiment of the present invention, an article of apparel for wearing by a wearer includes a first apparel portion and a second apparel portion which is positioned over a definable body part of the wearer when worn by the wearer, wherein said definable body part is identified within the second apparel portion in a written foreign language.

### BRIEF DESCRIPTION OF THE DRAWINGS

FIG. 1 is a front elevational view of an infant pajama showing an embodiment of the present invention;

FIG. 2 is a front elevational view of an infant pajama showing another embodiment of the present invention;

FIG. 3 is a front elevational view of a shirt showing another embodiment of the present invention;

FIG. 4 is a front elevational view of a dress showing another embodiment of the present invention;

FIG. 5 is a front elevational view of an infant pajama showing another embodiment of the present invention;

FIG. 6 is a front elevational view of an infant pajama showing another embodiment of the present invention;

FIG. 7 is a front elevational view of an infant pajama showing another embodiment of the present invention; and

FIG. 8 is a front elevational view of an infant pajama showing another embodiment of the present invention.

### DETAILED DESCRIPTIONS

The present invention is directed to an article of apparel which assists in teaching English or a foreign language vocabulary to the wearer and to those who view the article of apparel. The article of apparel may be of any type, including pants, shirts, pajamas, dresses, skirts, hats, socks, and infant and toddler apparel, accessories, etc. The language vocabulary taught by the apparel may be any word or words, which may or may not use the Latin alphabet. For example, the apparel of the present invention may assist in teaching vocabulary of English, Spanish, German, French, Italian, or other foreign languages using the Latin alphabet, but may also assist in teaching vocabulary of Chinese, Russian, Korean, Arabic, or other foreign languages not using the Latin alphabet.

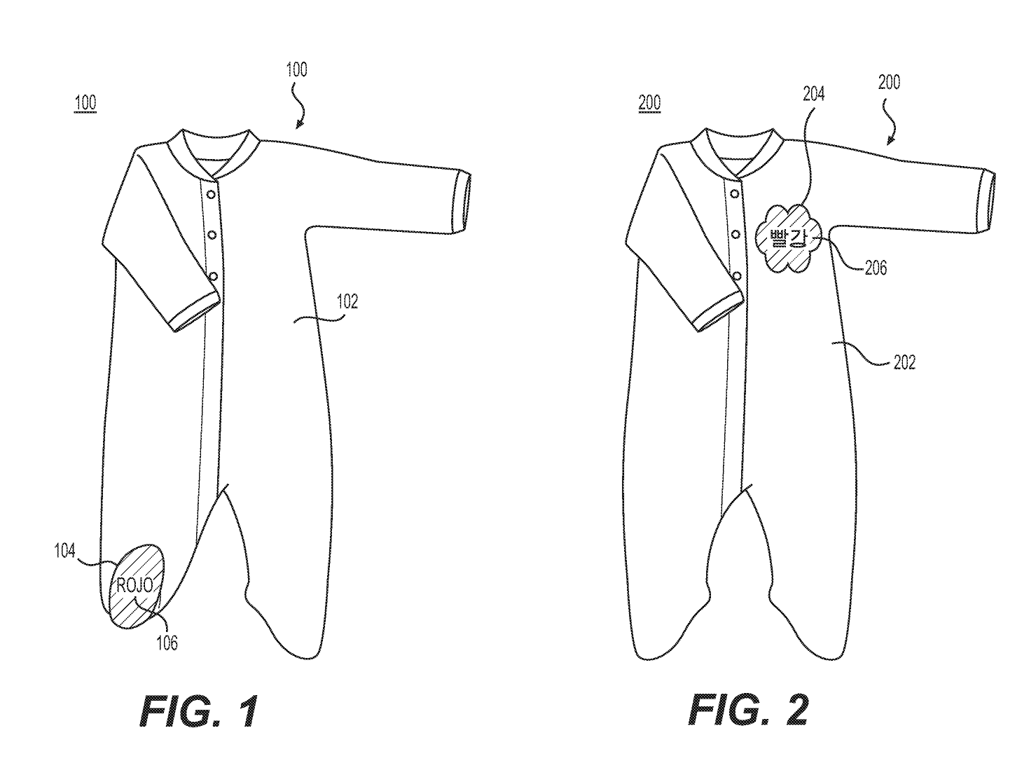

Referring now to FIGS. 1-8, the features of the present invention will be described in more detail herebelow.

FIG. 1 shows a front view of an infant pajama 100 showing an embodiment of the present invention. The infant pajama 100 includes a first apparel portion 102 and a second apparel portion (also referred to as a teaching portion) 104. Second apparel portion 104 is located around a foot of the infant pajama 100. First apparel portion 102 has a first color, such as white. The teaching portion 104 has a color that is different from the color of the first apparel portion 102. The color of the teaching portion 104 is identified in a written foreign language 106. The color identification 106 is indicated within the teaching portion 104. In FIG. 1, the first apparel portion 102 is white, and the teaching portion 104 located in the foot portion of the infant pajama 100 is red. The color red is identified within the teaching portion 104 as “rojo”, which is “red” in Spanish.

Referring now to FIG. 2, an alternative embodiment of the present invention is shown. The first apparel portion 202 is white. The second apparel portion (teaching portion) 204 may be located anywhere in the infant pajama 200, such as the front, back, or the side of the infant pajama 200, but preferably in a location easily visible to the viewers of the infant pajama 200. In the embodiment shown in FIG. 2, the teaching portion 204 is located near the chest portion of the infant pajama 200. Further, the teaching portion 204 is shown as having a boundaried shape and is red. In this embodiment, however, the color identification 206 states “ [symbol] ”, which is “red” in Korean.

By contrasting the colors of two different portions of an apparel and identifying the contrasted color in a foreign language within the teaching portion, the wearer or viewer of the apparel can associate and recognize the foreign language vocabulary as identification of the color of the teaching portion. The second apparel portion (teaching portion) may be of varying shapes, sizes, or patterns.

It would be apparent to one skilled in the art for the present invention to have different types of apparels, colors, positions, shapes, and foreign languages. FIGS. 1 and 2 show exemplary embodiments of different types of apparels implementing the present invention.

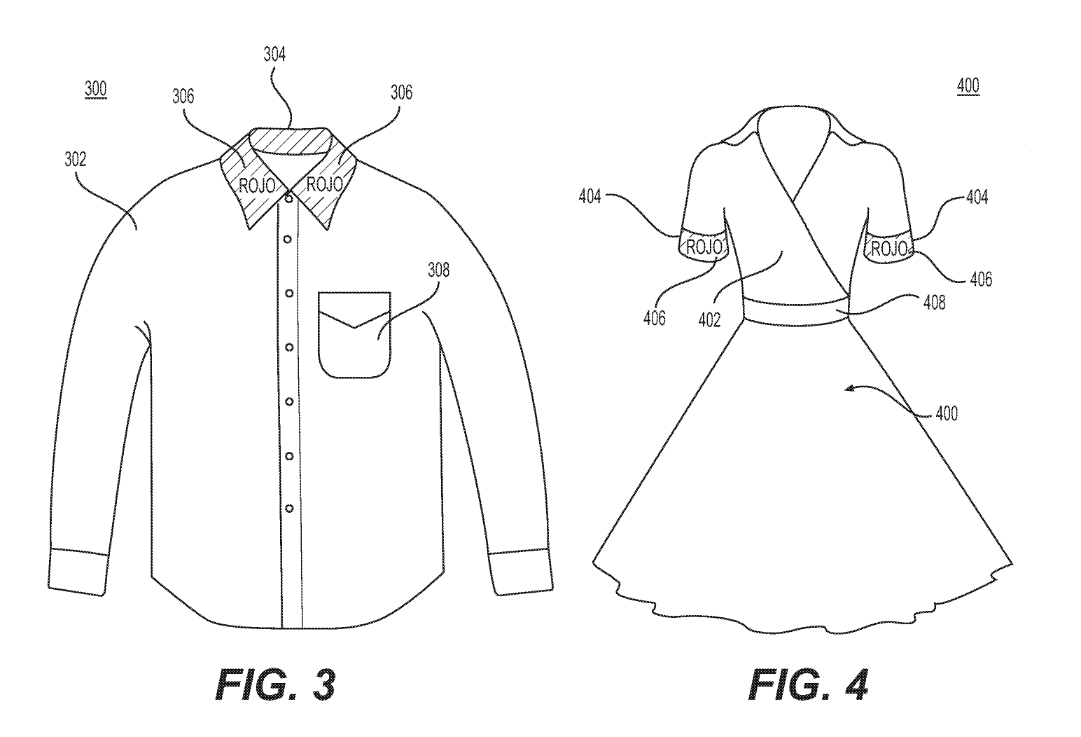

Referring now to FIG. 3, a shirt 300 having a collar 304 is shown. The shirt 300 has a different color from the collar 304, which is identified as being red in Spanish (“rojo” 306). In this embodiment, the teaching portion is the collar 304. However, the second apparel portion is not limited to the collar 304, and it may be positioned at different locations of the shirt, such as the pocket 308. Further, there may be more than one teaching portions such that both the collar 304 and the pocket 308 may have differing colors from the shirt 300 and/or from each other, and each color of the teaching portions may be identified in a same or different foreign language.

It is also apparent to one skilled in the art that a pair of pants or shorts can be an apparel of the present invention having a first apparel portion and a second apparel (teaching) portion, wherein the second apparel portion is a pocket. The pants or shorts pocket has a color different than that of the first apparel portion, and the color of the pocket is identified in a written vocabulary, which may be in English or a foreign (non-English) language.

In FIG. 4, another embodiment is shown in a dress 400. Dress 400 includes a first portion 402 having one color and a teaching portion which is a pair of sleeves 404, and which has a different color from the dress 400. The color of the sleeves 404 is identified as being red in Spanish (“rojo” 406). Again, the teaching portion is not limited to one particular feature of an article of apparel, such as the pair of sleeves 404, and there may be more than one teaching portion in an article of apparel. For example, the waist band portion 408 may be a teaching portion instead of, or in addition to, the pair of sleeves 404.

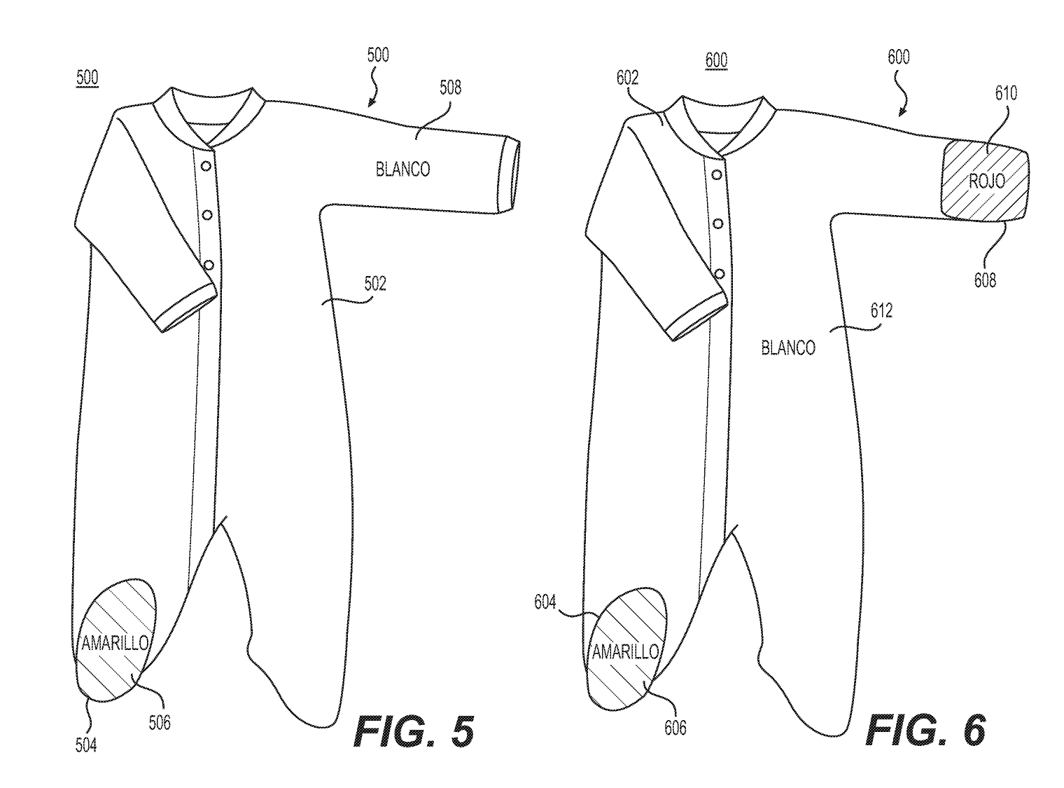

In another embodiment of the present invention, an infant pajama 500 is shown in FIG. 5, having a first portion 502 and a second portion 504. In this embodiment, both first and second portions 502 and 504 may be teaching portions such that the colors of both portions 502 and 504 are identified in a foreign language. In this embodiment, the first portion 502 is white, and the first color identification 508 indicates the color as white in Spanish (“blanco”). Further, second portion 504 is yellow, and the second color identification indicates the color as yellow in Spanish (“amarillo” 506).

Referring now to FIG. 6, there is shown a front view of an infant pajama 600 having a first portion 602, a second portion 604 positioned at a foot 606 of the infant pajama 600, and a third portion 608 positioned at a hand 610 of the infant pajama 600. Each of the three portions are teaching portions as each of the portions have a color different from the other portions and the colors of each portions are identified in a foreign language. In FIG. 6, the first portion 602 is white and is identified as white in Spanish (“blanco”). Likewise, the second and third portions 604 and 608 are yellow and red, respectively, and are identified as yellow and red in Spanish, respectively (“amarillo” and “rojo”).

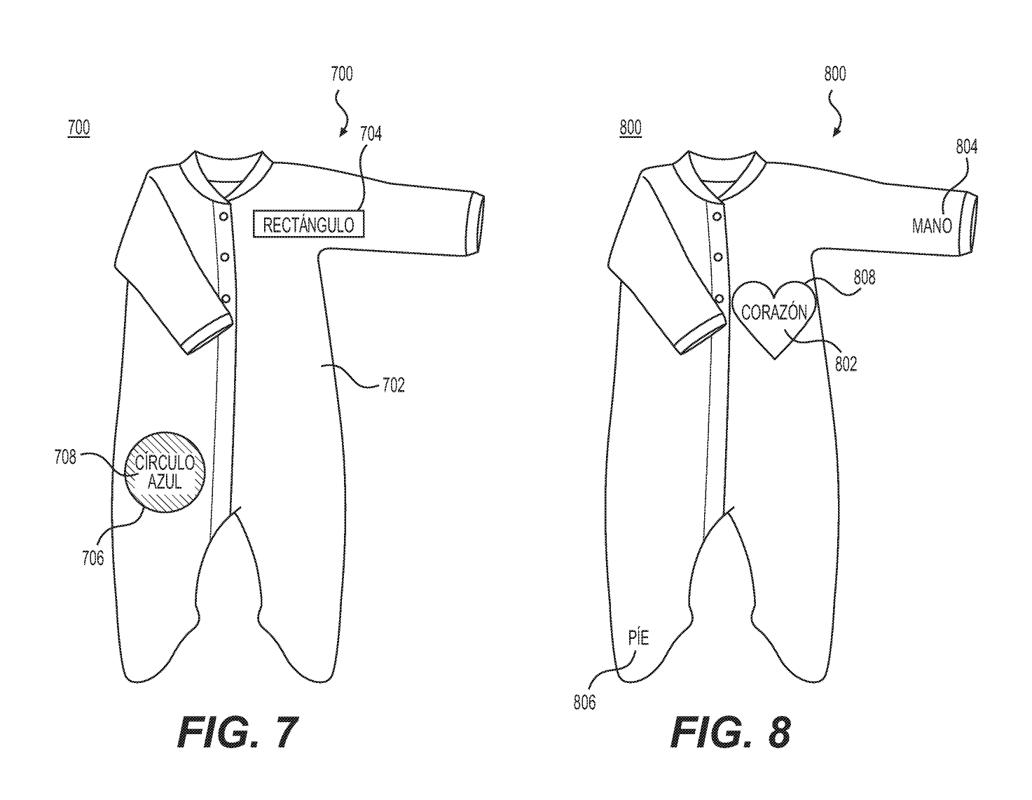

The present invention may assist in teaching the wearer or the viewer of the article of apparel foreign language vocabulary other than colors. For example, as shown in FIG. 7, foreign language vocabulary for geometric shapes and/or colors may be included. The infant pajama 700 includes a first portion 702, a first geometric portion 704, and a second geometric portion 706. The first geometric portion 704 has a shape of a rectangle and is identified as a rectangle in Spanish (“rectángulo”) inside the portion 704. The second geometric portion 706 has a shape of a circle and also has a blue color. Thus, the second geometric portion 706 is identified as a blue circle in Spanish (“círculo azul” 708) inside the portion.

The present invention may also assist in teaching of foreign language vocabulary related to body parts. FIG. 8 shows an infant pajama 800, which includes identification of certain body parts. In FIG. 8, the portions of the infant pajama 800 covering the heart 802, hand 804, and foot 806, are identified accordingly in Spanish—“corazón”, “mano”, and “pie”, respectively. The body parts may or may not be shown in a boundaried shape, such as the heart shape 808 around the Spanish word “corazón”.

Although not shown in the drawing figures, the article of apparel of the present invention may also assist in teaching foreign language vocabulary corresponding to objects, persons, animals, actions, etc. The present invention may also teach foreign language vocabulary for descriptive adjectives. For example, an embodiment apparel of the present invention may include a drawing or shape of an airplane and identify it as an airplane in a foreign language. Similarly, another embodiment apparel may include a drawing or shape of a dog and identify it in foreign language. Furthermore, another embodiment apparel may include a small drawing or shape of a book and a larger drawing or shape of a book, and identify “small book” and “large book” in a foreign language to assist in teaching vocabulary for commonly used adjectives and/or nouns.

The accompanying drawings described above show exemplary embodiments of the present invention for the purpose of assisting understanding of the present invention with the detailed description of the embodiments. The drawings should not be interpreted to limit the present inventions in any aspect. It is apparent to one of ordinary skill in the art that the type of apparel, positions and shapes of the teaching portion(s), colors, foreign languages and foreign language vocabularies, may be added, deleted, altered, and/or varied amongst embodiments of the present invention. Further, although the use of Spanish is primarily illustrated in the Figures, the language could also be English or any other non-English foreign language.

1. An article of apparel comprising:
a first apparel portion having a first color; and
a second apparel portion having a second color which is different from the first color,
wherein the second color is identified within the second apparel portion in a non-English written language.

2. The article of apparel of claim 1, wherein said non-English written language is Spanish.

3. The article of apparel of claim 1, wherein the article of apparel is for wearing by an infant or a toddler.

4. The article of apparel of claim 3, wherein said second apparel portion covers a foot of said infant or toddler.

5. The article of apparel of claim 1, wherein said article of apparel is a dress and said second apparel portion is a sleeve of said dress.

6. The article of apparel of claim 1, wherein said article of apparel is a shirt and said second apparel portion is a single collar of said shirt.

7. The article of apparel of claim 1, wherein said first color of said first apparel portion is identified within said first apparel portion in said non-English written language.

8. The article of apparel of claim 1, wherein the second apparel portion is detachably attached to the article of apparel.

9. An article of apparel comprising:
a first apparel portion; and
a second apparel portion which is positioned within a boundary having a definable geometric shape,
wherein said definable geometric shape is identified within the second apparel portion in a non-English written language.

10. The article of apparel of claim 9, wherein said non-English written language is Spanish.

11. The article of apparel of claim 9, wherein said first apparel portion has a first color and said second apparel portion has a second color which is different from the first color, and wherein the second color is identified within the second apparel portion in said non-English written language.

12. The article of apparel of claim 11, wherein said non-English written language is Spanish.

13. The article of apparel of claim 9, wherein the article of apparel is for wearing by an infant or a toddler.

14. The article of apparel of claim 13, wherein said second apparel portion covers a foot of said infant or toddler.

15. The article of apparel of claim 9, wherein the second apparel portion is detachably attached to the article of apparel.

16. An article of apparel for wearing by a wearer comprising:
a first apparel portion; and
a second apparel portion which is positioned over a definable body part of the wearer when worn by the wearer,
wherein said definable body part is identified within the second apparel portion in a non-English written language.

17. The article of apparel of claim 16, wherein said non-English written language is Spanish.

18. The article of apparel of claim 16, wherein the article of apparel is for wearing by an infant or a toddler.

19. The article of apparel of claim 16, wherein said first apparel portion has a first color and said second apparel portion has a second color which is different from the first color, and wherein the second color is identified within the second apparel portion in said non-English written language.

20. The article of apparel of claim 16, wherein the second apparel portion is detachably attached to the article of apparel.
